(19) United States
(12) Patent Application Publication
(10) Pub. No.: US 2010/0020564 A1
(43) Pub. Date: Jan. 28, 2010

(54) Structure in a water pipe lamp

(76) Inventor: Fong-Shi Lin, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/219,719

(22) Filed: Jul. 28, 2008

(51) Int. Cl. F21V 8/00; H05B 37/00

(52) U.S. Cl. 362/551; 315/185 R

(57) ABSTRACT

The present invention is to provide a kind of new structure of water pipe lamp. The said water pipe lamp is layout with hollowing-out and elastic net-grid sleeved tube which is directly sleeve-deposed a lamp string or sleeve-deposed over in an inner tube deposed with lamps. With this structure, the water pipe lamp can proceed the lamp exchange through the hollowing-out net grid. At the same time, through the action of enveloping of net-grids, the emitted light from lamps can form a radiative lightening effect.

### BACKGROUND OF THE INVENTION

Those shown in FIGS. 1 and 2 are forms of normally seen water pipe lamps in the prior art, wherein the water pipe lamp in FIG. 1 is constructed of a sleeved tube 10 with light permeating ability, an inner tube 20 and a lamp string set with multiple lamps 31. The said inner tube 20 is set with a trough 21 for deposing in the lamp string 30 through here. The sleeved tube 10 is then immediately sleeved over the inner tube 20, and is seal-covered (not shown the in figure) at the front and rear ends to form a water pipe lamp. However, the worse disadvantage in this water pipe lamp is not able to proceed the exchange while damaged unless the whole set of water pipe lamp is dismantled. But, this will definitely bring out the damage of the whole set of water pipe lamp because of the tight jointing method of assembly in the water pipe lamp shown in FIG. 2. It is unable to be dismantled unless destroying it. And, the water pipe lamp shown in FIG. 2 is also composed of a sleeved tube 10 with light permeating ability, an inner tube 20 and in conjunction with multiple small single lamps 40. Multiple round troughs are set on the said inner tube 20 in an isometric way for the deposition of the small lamps 40, and the connecting pins 41 of every small lamp 40 are mutually conduct-connected with each other. Then, the sleeved tube 10 is enveloped over the inner tube 20, and again one tap each is fix-connected at the front and rear ends (not shown in the figure) to form a water pipe lamp. However, the worse disadvantage in this kind of water pipe lamp is the same as that of aforementioned, that is, it is not able to proceed the exchange of its small lamps 40.

### SUMMARY OF THE INVENTION

The present invention is related to an improved design in a water pipe lamp, which is layout with hollowing-out elastic net-grid sleeved tube to provide a direct sleeve-deposition of a lamp string for forming a net-grid tube shaped water pipe lamp. Through this, the water pipe lamp can be equipped with a function of operating the simple lamp exchange and the object of increasing the practicability is thus obtained. The structure and characteristics of the present invention are now described hereafter in cooperation with the drawings.

### BRIEF DESCRIPTION OF THE DRAWINGS

FIG. 1 is a diagram of the water pipe lamp in the prior art.

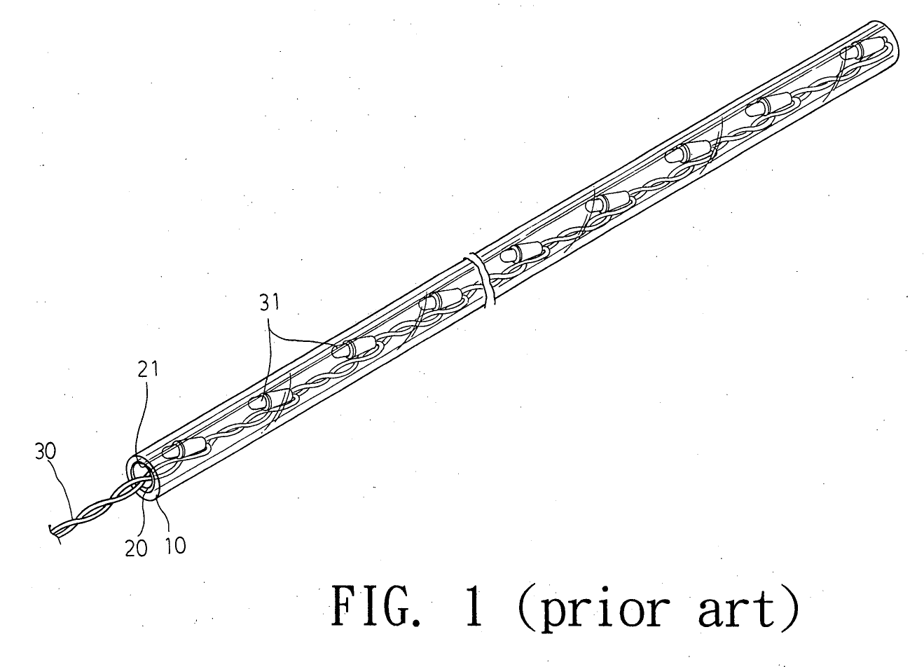

FIG. 2 is another diagram of the water pipe lamp in the prior art.

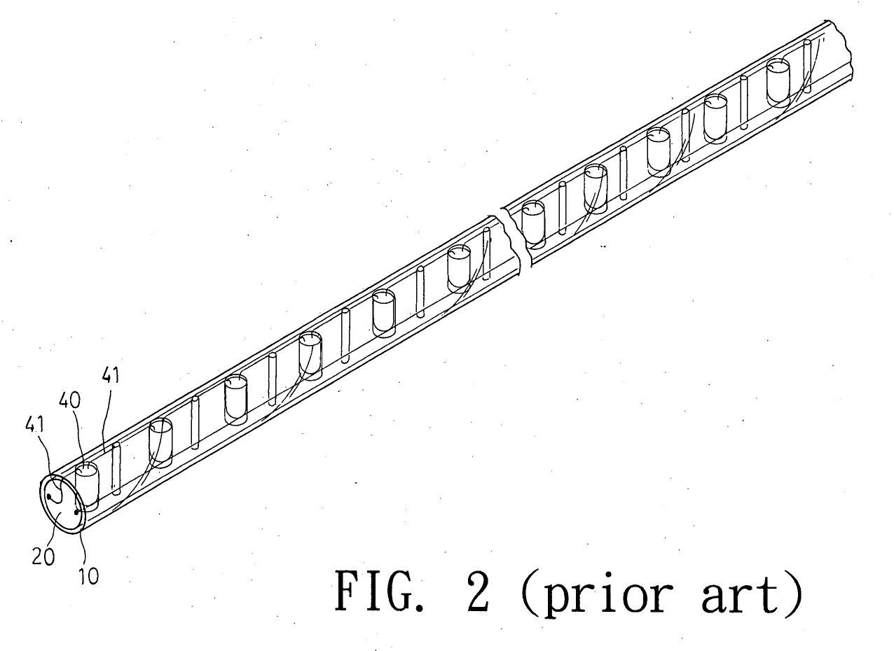

FIG. 3 is a form diagram of the water pipe lamp according to the present invention.

FIG. 4 is another embodiment of the form diagram in the water pipe lamp of the present invention . . .

### DETAILED DESCRIPTION OF THE PREFERRED EMBODIMENT

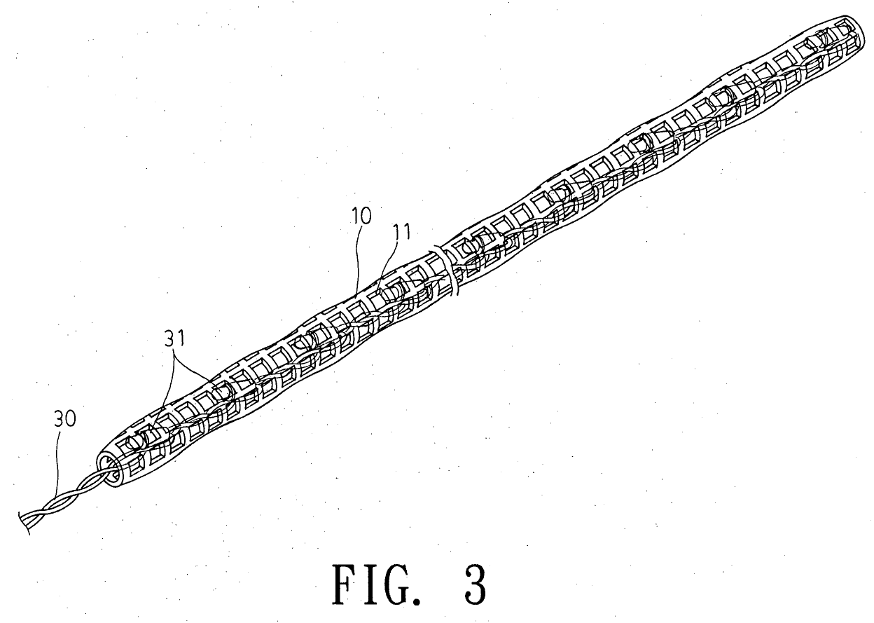

Please refer to FIG. 3. The present invention is a kind of new structure in the water pipe lamp, which includes a sleeved tube 10 directly sleeve-covered with a lamp string set with multiple lamps 31. The said sleeved tube 10 is made of a kind of plastic material with elasticity and ductility, and isometrically-layouted hollowing-out and elastic net-grids 11 are set on the sleeved tube 10. As a whole, it is also equipped with excellent light permeating ability, and its hollowing-out grids can be square, diamond, round shapes or other different geometrical shapes.

Therefore, the present invention utilizes the sleeved tube 10 layout with hollowing-out net-grids 11 to sleeve-cover tightly over the lamp string 30 and its lamps 31 to form a net-grid shaped water pipe lamp. Thus, while there are lamps 31 in the lamp string 30 damaged, openings of the net-grids 11 where the damaged lamps are located can be pull-widened, and the damaged lamps 31 are taken out then exchanged through the net-grids 11. And, after the relieving of pulling-open forces, the net-grids 11 are restored to their original shapes. This makes the water pipe lamp in the present invention be equipped with a function of exchanging lamps simply and conveniently and let the water pipe lamp be further equipped with the practicability. Furthermore, due to the sleeve-covering in the net-grids 11 of the sleeved pipe 10, a non-flat smooth surface is formed. Therefore, the light source of the lamps 31 are permeated through net-grids 11 then refracted, and a kind of radiative shaped light can be revealed such that the whole water pipe lamp can be more glaring and appealing after lightened.

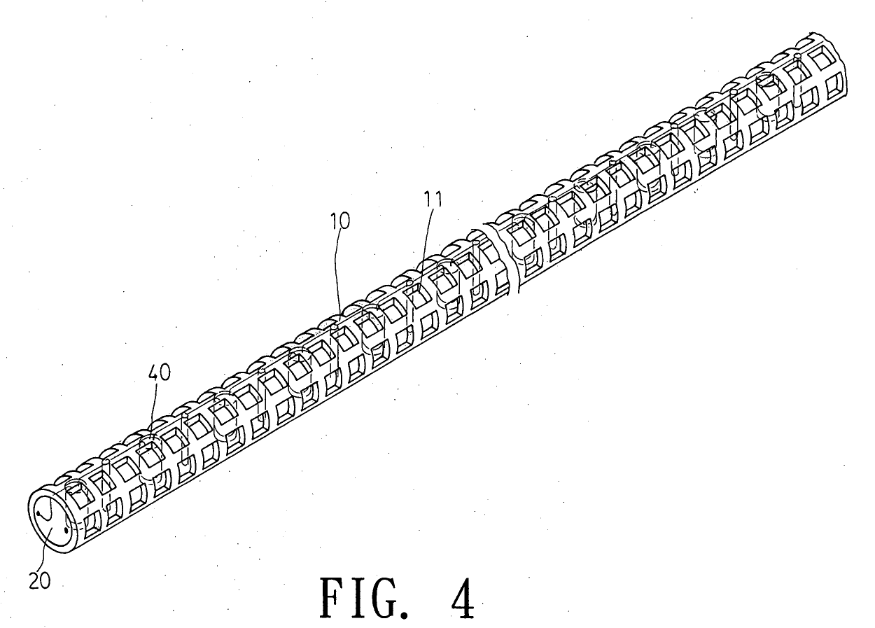

Please refer to FIG. 4. It is another embodiment structure of the present invention, which utilizes the sleeved tube 10 layout with hollowing-out net-grids 11 to sleeve-cover the inner tube 20 lamp isometrically set with multiple round troughs and deposed with small lamps 40. Thus, while there is any one small lamp 40 in the inner tube 20 damaged, opening of the net-grid 11 where the damaged lamp is located can be pull-widened, and the damaged lamp 40 is taken out then exchanged through the net-grid 11 that is all and achieve the same kind of convenience. Furthermore, the light source of every small lamps 40 are permeated through net-grids 11 then refracted, and a kind of radiative shaped light can also be revealed such that the water pipe lamp can be equipped with certain glaring and appealing after lightened

I claim:

1. A kind of new structure in the water pipe lamp including a sleeved tube and a lamp string connect-set with multiple lamps, a tube body of the said sleeved tube is layout with hollowing-out and elastic net-grids and sleeve-set directly over the lamp string to form a net-grid shaped water pipe lamp.

2. A new structure of the water pipe lamp as claimed in claim 1, wherein the net-grids of the sleeved tube can be square, diamond, or round shapes.

3. A kind of new structure in the water pipe lamp including a sleeved tube and an inner tube connect-set with conductive wires and multiple small lamps, a tube body of the said sleeved tube is layout with hollowing-out and elastic net-grids and sleeve-set directly over the inner tube to form a net-grid shaped water pipe lamp.

4. A new structure of the water pipe lamp as claimed in claim 1, wherein the net-grids of the sleeved tube can be square, diamond, or round shapes.
